(19) United States
(12) Patent Application Publication
(10) Pub. No.: US 2004/0151822 A1
(43) Pub. Date: Aug. 5, 2004

(54) Method for enhancing post-processing content of beneficial compounds in beverages naturally containing same

(76) Inventors: Thomas J. Slaga, Golden, CO (US); Jifu Zhao, Littleton, CO (US); Mark Lange, Rougemont, NC (US); Loretta Zapp, Boulder, CO (US)

Correspondence Address: David G Henry, 900 Washington Avenue, PO Box 1470, Waco, TX, 76703-1470, US

(21) Appl. No.: 10/416,253

(22) PCT Filed: Nov. 20, 2001
(86) PCT No.: PCT/US01/44766

(51) Int. Cl. A23F 5/00

(52) U.S. Cl. 426/595

(57) ABSTRACT

Coffee processing methods and ground coffee end products which depends upon one or more processes for enhancing the post-processing polyphenol content of ground coffee beverage substrate. A first method involves the blending of portions of coffee beans which are variously roasted. The second method involves pre-soaking the beverage substrate before roasting and then quenching the substrate after processing with the liquid in which the substrate was first “pre-soaked”.

### CITATION TO PRIOR APPLICATION

This is a continuation-in-part with respect to U.S. application Ser. No. 09/717,890 filed 20 Nov. 2000 (20.11.00) from which priority is claimed under 35 U.S.C. §120 and under provisions of the Patent Cooperation Treaty.

### BACKGROUND OF THE INVENTION

1. Field of the Invention

The present invention relates to beverage substrate processing, pertaining most closely to coffee bean processing for use as coffee beverage substrate.

2. Background Information

This invention relates to new coffee beans with an increased phenolic acid and aroma contents, as well as to produce powder-form and instant coffee using the new beans.

Phenolic acids in coffee are mainly esters of quinic acid with different amount of caffeyl groups attached to its different positions. The phenolic acids present in coffee such as chlorogenic acid, caffeic acid, para-coumaric acid and eugenol have been shown to exert cancer preventive activities in animal models. Chlorogenic acid has also been found to inhibit methylazoxymethanol-induced large intestinal tumors in hamster.

Furthermore, it has now been found that coffee with a higher content of phenolic acids can be more easily digested. Chlorogenic acid, which is the main phenolic acid in coffee, is able to protect the gastric mucosa against irritations, and, therefore, improves the digestibility of foods, beverages and medicaments. The improved digestibility is expressed through a much reduced systemic acid secretion (such as causes heartburn, etc.) which has been found to be directly dependent on an increased level of chlorogenic acid content in roasted coffee.

It is clear, then, that a coffee processing methodology which yields an end product which is higher in phenolic acids (less is removed by the roasting process), but which lacks detrimental flavor alterations, would be a highly desirable contribution. Normally the natural chlorogenic acid content of coffee is reduced by approximately 40 to 80% during conventional roasting process. Analysis by the present inventor indicates that green coffee beans which initially contain 4% phenolic acids contain, respectively, 2% phenolic acids when light roasted, 1% when medium roasted, and less than 0.5% when dark roasted. This clearly represents a significant loss of beneficial compounds.

In addition to reducing beneficial chlorogenic acid constituent, conventional coffee roasting processes also produce a loss of overall weight (or the order of 12% to 17% of the initial raw coffee bean weight). The weight loss is due to the loss of residual moisture content still present in the raw coffee after drying, and through the loss by evaporation or chemical composition, of various constituents of the raw coffee, including the phenolic acids. Weight represents money to processed coffee vendors, so, in addition to inherently providing a more beneficial product which happens to be heavier because of a higher residual content of phenolic acids, producing a heavier processed coffee per unit green coffee bean input is simply an economic benefit to the vendor.

To continue the litany of problems with conventional coffee roasting processes: roasting also destroys natural aroma of green coffee beans, and generates bad compounds, such as 4-aminobiphenyl (ABP), 2-amino-1-methyl-6-phenyllimidazo[4,5-b]pyridine (PhIP) and glyoxal.

In view of the above, it is clear that it would be quite beneficial to humankind to provide some method, or combination of methods, which would elevate the post-processing polyphenol content of coffee, without adversely affecting the taste of the beverage.

It is also an object of the present invention provide an improved coffee processing method.

It is another object of the present invention to provide an improved coffee product.

It is another object of the present invention to provide an improved raw coffee processing method which yields a more healthful end product.

It is another object of the present invention to provide an improved raw coffee processing method which yields processed coffee beans or powdered coffee which is higher in weight per unit green bean input than product processed by conventional methods.

It is another object of the present invention to provide an improved raw coffee processing method which yields an end product which is higher in phenolic acid content per than coffee product which is processed by conventional methods.

It is another object of the present invention to provide an improved raw coffee processing method which yields a more easily digestible end product.

It is another object of the present invention to provide an improved raw coffee processing method which yields a more healthful end product, without any undesirable taste alterations.

In satisfaction of these and related objects, the present invention provides two novel and unobvious coffee processing methods (and ground coffee end products). The processes are useful independently, and in combination, with the greatest anticipated results being realized from the combination of the two methods.

The first method depends upon the blending of portions of coffee beans which are variously roasted (green, slightly roasted, medium roast and dark roast). Remarkably, this simple method produces a coffee end product which is more flavorful (through a reduced loss of natural aromas from green, light, medium and dark roasted beans), more antioxidants (phenolic compounds), more diterpenes (having detoxification properties) and less DNA-damaging compounds which are generated during roasting of coffee, especially dark-roasted coffee. The new coffee keeps the smell and taste of conventional dark-roasted coffee and as well have fresh taste and smell from green and light-roasted beans.

The second process involves, in the preferred mode, the remarkably simple process of soaking coffee beans in plain water prior to roasting, and, after roasting, “quenching” the beans with a portion of the pre-soak liquid (the solvent water, plus the polyphenols released into the water). This substantially enhances the post-roasting polyphenol content of roasted coffee beans.

When the two processes are combined, the potential for post-processing polyphenol content of ground coffee made from the uniquely processed beans (and beverage made from the ground coffee) is great indeed. Nevertheless, it is important to note that the two processes are useful and produce highly beneficial results independently of each other.

### DETAILED DESCRIPTION OF THE PREFERRED EMBODIMENT

As mentioned above, the present invention encompasses two processes, as well as the combination of two processes. The first process involves a blending of differently roasted coffee beans, which results in an “averaging” of polyphenol content in a finished beverage. The second process is one which replaces polyphenol content in roasted beans which was lost during the roasting process. These processes are independently quite beneficial, but in combination can provide benefits as yet unheard of in the coffee beverage industry.

A. Blending of Variously Roasted Coffee Beans.

The new powder-form coffee of the preferred mode of the present invention is the product of blending portions of variously roasted coffee beans. This is a significant departure from conventional coffee processes methods, where all of the beans which contribute to an end product are roasted to substantially the same degree as the desired end product degree of roast dictates, whereas the end product of this process the present invention achieves the perceived degree of roast through what might loosely be called an “averaging” of the roast of the plural portions of a blended coffee bean product. Surprisingly, brewed coffee made from the blended coffee powders of the present invention are perceived by consumers as being substantially of the degree of roast of the darkest roast constituent. Thus, a blend containing a relatively high proportion of slightly roasted beans still gives a product which, from the sensory standpoint, corresponds to a coffee with the higher degree of roasting of the other portions (if the latter portions of more darkly roasted beans is more than negligible—say more than 10% by weight). On the other hand, substantial health benefits and increased tolerability of brewed coffee will arise from a constituence of more than a negligible amount of the beans of a lesser degree of roast than that desired to be perceived by consumers.

To the consumer, there is little change in the perceived taste of the product, yet that which is consumed is substantially more healthful and easily tolerated.

Variations in the blending of multiply roasted coffee beans will arise from differing desired end results. Following are examples of blends made under this process of the present invention, each using Brazilian green coffee beans which were determined to contain 4.4% of phenolic acids by UV photometric method and 2.8% of chlorogenic acid.

### EXAMPLE 1

A blend of coffee beans is prepared according to the following constituency: one fourth by weight of green beans (no roasting), one fourth of beans being slightly roasted, one fourth being roasted to “medium dark”, and the last one fourth is roasted to a “dark roast.” The four portions are mixed together and ground to get new coffee I.

Chemical analysis showed that the new coffee I contains 2.9% of phenolic acids and 1.5% of chlorogenic acid; whereas dark-roasted beans alone only contain 0.9% of phenolic acids and 0.6% of chlorogenic acid. Because PhIP, glyoxal and so on are only present in roasted, especially dark-roasted beans, the new coffee I contains much lower levels of those harmful compounds.

### EXAMPLE 2

A blend of coffee beans is prepared according to the following constituency: one third by weight of beans being slightly roasted, one third being roasted to “medium dark”, and the last third is roasted to a “dark roast.” The three portions are mixed together and ground to get new coffee II.

Chemical analysis showed that the new coffee II contains 2.2% of phenolic acids and 1.2% of chlorogenic acid, and contains significantly lower levels of of PhIP, glyoxal and other harmful compounds than like weight of conventionally roasted coffee powders.

### EXAMPLE 3

A blend of coffee beans is prepared according to the following constituency: one half by weight of beans being slightly roasted, one third being roasted to “medium dark”, and the last one-sixth is roasted to a “dark roast.” The three portions are mixed together and ground to get new Coffee III.

Chemical analysis showed that the new coffee III contains 2.7% of phenolic acids and 1.4% of chlorogenic acid.

During any of the roasting methods described above (or upon using variations thereof), the coffee may be flavored or supplemented with desired additives by conventional methods.

The invented procedures can also be used for producing decaffeinated or partly decaffeinated roasted coffee, in that a raw coffee is used as a basis and then the caffeine is partly or totally removed therefrom. Instant coffee can also be obtained by using newly-invented coffee beans as starting material.

In the preceding examples, all percentages are reported by weight. The chlorogenic acid contents given were obtained by high pressure liquid chromatography (HPLC) and UV photometric methods.

The preceding examples illustrate that a more healthful and more easily tolerated coffee product can be produced by a very simple variation of conventional coffee processing methods. In addition, an end product which is heavier per unit raw substrate input can be produced by the same method, and thereby provide an economic benefit to vendors. The present method yields a product which is in no way undesirable from an aesthetic standpoint. Thus, there is no reason not to, and every reason to, adopt this coffee processing methods for the well-being of consumers.

B. Replacement of Lost Polyphenols in Roasted Coffee Beans by After-Roasting “Quenching”.

Additional research by the present inventors produced a finding that post-processing chlorogenic acid content in particular, and total polyphenol content in general, can be substantially enhanced for brewed coffee through an additional, remarkably simple process. The same is true of other brewed beverages the counterpart substrates of which are known to have a significant polyphenolic constituent. Therefore, while the predominant discussion in this portion of the specification focuses on coffee, it must be understood that similar results can be obtained through practice of this method of the present invention in the context of producing beverages from other materials which naturally contain polyphenolic acids (teas, for example).

Both condensed tannin and polyphenolic acids in coffee beans have low water-solubility. According to experiments by the present inventors, under most circumstances, even hot water cannot significantly dissolve coffee polyphenols out of coffee. Something more than water at elevated temperatures applied at some random point in coffee beverage making is required to most significantly enhance the extraction of coffee polyphenols out of coffee beans and powder.

The present inventors have discovered that, if applied in the manner prescribed herein, the remarkably simple process of soaking coffee beans in plain water prior to roasting, and, almost immediately after roasting, “quenching” the beans with a portion of the pre-soak liquid (the solvent water, plus the polyphenols released into the water) will substantially enhance the post-roasting polyphenol content of coffee beans. This represents yet another significant leap forward in the present inventors' work in optimizing the post-processing polyphenol content of coffee as a means for delivering health-enhancing agents to consumers in a most non-intrusive and cost effective manner.

The process of the present invention, when compared with earlier, related processes developed by the present inventors, not only provides a substantial health benefits potential, but permits such benefits to be realized, and the product which carries the benefits to be distributed and sold, with no market or distribution related impediments or inconveniences. This is true, in part, because, unlike some of the referenced prior processes (the subject of first parent application relating to this continuation application) the process for spiking polyphenolics pursuant to the present invention, at least in the case of coffee, takes place at the commercial, roasting stage, rather than at the retail sales level and is, therefore, completely transparent to the end consumer.

Illustrative examples of this process of the present invention follow. It should be understood, of course, that commercial processing according to the present invention will take place on much larger scales than the illustrative examples provided, with proportional increases in the respective constituents (coffee beans, water, pre-soak liquid used for quenching, etc) for larger batches. The first described example is presently believed to be the optimal mode for this process.

According to the most economical version of the instant process, raw, green coffee beans are “pre-soaked” in water as described in more detail hereafter, and a portion (approximately 10% to 20%) of the same water is later used to quench the same beans immediately after roasting. However, as shown below, variations of the same invention involve pre-soaking green coffee beans, roasting other beans, and quenching the roasted beans with the solution from soaking the first, non-roasted beans. These later methods yield end products of even greater phenolics content.

### EXAMPLE 1

Raw green coffee beans are pre-soaked in water for 3 hours at 75° C. 1000 grams of green beans soaked in 2000 mls of water. 1000 mls of pre-soak solution (water used for pre-soaking) was retained after beans are removed from water for roasting. Pre-soaked green beans are roasted in a traditional coffee roaster with temperature starting at 350° F. and increasing to 430° F. over a period of approximately 15-18 minutes.

At the conclusion of the roast, the beans are dropped into a container and immediately quenched with 150 mls of the pre-soak solution. The roasted beans are then ground to a powder and brewed with hot water to produce a coffee beverage.

Chemical analysis showed that the new beverage contains over 20%-65% of the pre-roasted phenolic acid content, specifically representing chlorogenic acid content at 40%-150% (depending on degree of roast—bigger increase with darker roast) over that in traditional roasted coffee of a similar roast color;

### EXAMPLE 2

Raw green coffee beans are pre-soaked in water for 3 hours at 80° C. 1000 grams of green beans soaked in 2000 mls of water. 1000 mls of pre-soak solution was obtained. Pre-soak water is collected for later quenching step. 1400 grams of regular green coffee beans are roasted in a traditional manner. Upon completion of the roast the beans are split into a control and an experimental group and subsequently quenched with either 150 mls of water (control) or 150 mls of the pre-soak solution that has been previously collected from green beans. (experimental). The green beans used to create the pre-soak quenching solution are not the beans that are use in the roasting. The roasted beans are then ground to a powder and brewed with hot water to produce a coffee beverage.

Chemical analysis showed that the new beverage contains over 20%-70% of phenolic acid content, representing a 40%-200% chlorogenic acid content over that of the control of the same roast.

### EXAMPLE 3

Raw green coffee beans are pre-soaked in water for 3 hours at 80° C. 1000 grams of green beans soaked in 2000 mls of water. 1000 mls of pre-soak solution was obtained. Pre-soak water is collected for later quenching step. A portion of the pre-soak water is collected and freeze dried to be used as a fortifying ingredient in the pre-soak quench. 1400 grams of regular green beans are roasted in a traditional manner. Upon completion of the roast the beans are split into a control and an experimental group and subsequently quenched with either 150 mls of water (control) or 150 mls of the pre-soak which has been fortified with 10 grams of freeze dried pre-soak. All pre-soak solution has been previously collected and/or collected and freeze dried from green beans. (experimental). The green beans used to create the pre-soak quenching solution are not the beans that are use in the roasting. The roasted beans are then ground to a powder and brewed with hot water to produce a coffee beverage.

Chemical analysis showed that the new beverage contains over 120% of phenolic acids, representing approx 250% of chlorogenic acid content of conventionally processed coffee;

The powder from the preceding examples can be sold as coffee powder for brewing or can be brewed and sold as a ready-to-drink coffee beverage. The resulting product can be taken as a food or functional food by a human or other mammal, orally.

Conclusions:

The preceding examples illustrate that a more healthful polyphenol coffee beverage product can be produced by a very simple variation of conventional coffee roasting methods. In addition, an end product which is healthier and not much more costly than existing coffee powders can be produced, and thereby provide a market and economic benefit to vendors. The present method yields a product which is in no way undesirable from an aesthetic standpoint. Thus, there is no reason not to, and every reason to, adopt the present coffee roasting processing methods for the well being of consumers.

The processes of the present invention represent significant departures from conventional production of roasted coffee products, where green beans are simply roasted and may or may not be quenched with water, whereas the end product of the present invention achieves a chemical profile of increased amounts of phenolic acids and other beneficial compounds which is different from existing roasted coffee brews. This new process yields more active, more bioavailable, and larger quantities of phenolic compounds in end beverage products than can be realized following conventional coffee bean processing methods.

Although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the present invention.

I claim:

1. A method for enhancing polyphenolic acid content in post-processing beverage substrates comprising the steps of:
selecting a measure of beverage substrate known to contain polyphenolic acids;
immersing said beverage substrate in a pre-soak liquid containing water;
removing said beverage substrate from said pre-soak liquid and roasting said beverage substrate; and
quenching said beverage substrate after said roasting with a portion of said pre-soak liquid.

2. The method of claim 1 wherein said beverage substrate is coffee beans.

3. A method for enhancing polyphenolic acid content in post-processing beverage substrates comprising the steps of:
selecting a first measure of beverage substrate known to contain polyphenolic acids;
immersing said first measure of beverage substrate in a pre-soak liquid containing water;
collecting said pre-soak liquid after said immersing;
roasting a second measure of a beverage substrate; and
quenching said second measure of beverage substrate after said roasting with a portion of said pre-soak liquid.

4. The method of claim 1 wherein said first beverage substrate comprises coffee beans

5. The method of claim 1 wherein said second beverage substrate comprises coffee beans.

6. The method of claim 1 wherein said first beverage substrate and said second beverage substrate comprise coffee beans.

7. The method of claim 1 wherein said first beverage substrate consists essentially of coffee beans

8. The method of claim 1 wherein said second beverage substrate consists essentially of coffee beans.

9. The method of claim 1 wherein said first beverage substrate and said second beverage substrate consist essentially of coffee beans.

10. A method for producing ground coffee which, per unit weight, contains higher constituency of beneficial compounds than a like unit weight of ground coffee produced through conventional methods, and a lesser constituency of deleterious compounds, comprising the steps of:
selecting a first measure of coffee beans which are of a lesser degree of roast than desired overall degree of roast of the intended end product ground coffee, said first measure constituting not less than approximately 10% by weight of the intended end product weight;
selecting a second measure of coffee beans which are of a higher degree of roast than said first measure;
combining ground coffee produced by grinding said first and second measures to produced a blended coffee mixture, ground coffee produced from said first and second measures respectively contributing not less than 10%, nor more than 90% by weight of said blended coffee mixture.
